(19) United States
(12) Patent Application Publication
(10) Pub. No.: US 2016/0321293 A1
(43) Pub. Date: Nov. 3, 2016

(54) METHOD AND SYSTEM FOR SYNCHRONIZING FILES BETWEEN A FIRST ELECTRONIC DEVICE AND A SECOND ELECTRONIC DEVICE

(71) Applicant: YANDEX EUROPE AG

(72) Inventor: Clemens AUER, Moscow (RU)

(21) Appl. No.: 15/109,224

(22) PCT Filed: Oct. 7, 2014
(86) PCT No.: PCT/IB14/65125

§ 371 Date: Jun. 30, 2016

(30) Foreign Application Priority Data
Mar. 31, 2014 (RU) 2014112019

(51) Int. Cl. G06F 17/30; H04L 29/08

(52) U.S. Cl. CPC G06F 17/30174; H04L 67/1095; G06F 17/30321

(57) ABSTRACT

Method for managing file synchronization between a first filesystem of a first electronic device and a second filesystem of a second electronic device, the first electronic device being in communication with the second electronic device via a communications network, the method comprising identifying files to be synchronized between the first filesystem and the second filesystem; and generating an index that includes, in respect of each one of the files, an indication of each of a first state associated with the first filesystem, a second state associated with the second filesystem, and a third state being a synchronized state. Also electronic devices for carrying out the method and computer-readable media storing program instructions for carrying out the method.

### CROSS-REFERENCE

The present application claims convention priority to Russian Patent Application No. 2014112019, filed Mar. 31, 2014, entitled “METHOD AND SYSTEM FOR SYNCHRONIZING FILES BETWEEN A FIRST ELECTRONIC DEVICE AND A SECOND ELECTRONIC DEVICE” which is incorporated by reference herein in its entirety.

### FIELD

The present technology relates to methods and systems for synchronizing files between filesystems.

### BACKGROUND

It is becoming increasingly common for modern desktop and mobile computing environments to provide mechanisms for synchronizing files between filesystems of networked devices. These technologies provide a convenient mechanism for users to backup and/or remotely access their data over a communications network such as the Internet.

According to conventional technologies (with reference to FIG. 1), a first filesystem and a second filesystem are monitored. Periodically, a respective index of each filesystem is generated (e.g. using graph representations such as client index 110 and server index 120) and compared to a synchronization index (e.g. stable index 130) representative of the expected state of each of the first filesystem and the second filesystem. Any differences between the observed state and the expected state of each filesystem are then identified so as to determine a set of operations necessary to synchronize the two filesystems (e.g. file transfers, deletions, etc., depicted as 112 and 122 in FIG. 1). The operations are then carried out either sequentially or in parallel, and as each operation is completed, the synchronization index is updated to maintain a record of the current synchronization state.

For example, known systems and methods for sharing and synchronizing files between one or more computing systems are described in International Publication Number WO 2013/162387 A1, “Sharing and Synchronizing Files” (hereinafter “Besen”).

### SUMMARY

While conventional filesystem synchronization techniques may be effective for synchronizing files between filesystems, the inventor of the present technology has observed that they also present certain inconveniences and inefficiencies. Notably, the process of determining operations to be performed to synchronize files between filesystems in response to changes in one of the filesystems can demand substantial amounts of computational resources and/or processing time, especially as the number of files to be synchronized grows. The inventor has therefore devised improved methods and systems for managing synchronization of files between filesystems.

Briefly, aspects of the present technology are directed to methods (and related devices) for managing synchronization of files between filesystems by way of a unified index that includes state information in respect of a plurality of filesystems. By generating and maintaining such a unified index, the inventor of the present technology has observed that performance improvements may be achieved relative to conventional technologies which require maintenance and comparison of separate indexes in respect of each of the filesystems.

Accordingly, in one aspect, various implementations of the present technology provide a method for managing file synchronization between a first filesystem of a first electronic device and a second filesystem of a second electronic device, the first electronic device being in communication with the second electronic device via a communications network, the method comprising:
identifying files to be synchronized between the first filesystem and the second filesystem; and
generating an index that includes, in respect of each one of the files, an indication of each of a first state associated with the first filesystem, a second state associated with the second filesystem, and a third state being a synchronized state.

In some implementations, the method further comprises including, in the index, an association of each one of the files with at least one directory of a unified directory structure, the unified directory structure being indicative of both of a first directory structure with which the files are associated on the first filesystem and a second directory structure with which the files are associated on the second filesystem. In some but not necessarily all such implementations, the unified directory structure is a tree structure and the association of each one of the files with at least one directory of the unified directory structure is an association of each one of the files with only one respective directory of the unified directory structure. A directory structure which is a tree structure comprises a single root directory (a directory that is not a subdirectory of any other directory) and may also comprise other directories, each directory other than the root directory being a subdirectory of one and only one of the other directories (i.e. either the root directory or another one of the directories). In other implementations, there may be more than one root directory, and/or one or more directories may be a subdirectory of more than one other directory and/or one or more of the files may be associated with more than one of the directories. An example of such a non-tree directory structure is described in Besen with reference to a “cloud filesystem” (i.e. at Besen page 20, lines 5-9, and FIG. 4g), while noting that the terms “folder” and “subfolder” are used interchangeably with “directory” and “subdirectory”, respectively, by those skilled in the art.

The files to be synchronized between the filesystems may be identified by looking through the directory structure of one of the first directory structure and the second directory structure. Thus, in some implementations, identifying the files to be synchronized comprises receiving an indication of a synchronization directory being a directory of one of the first directory structure and the second directory structure, and identifying as the files each file being associated with at least one of the synchronization directory and at least one subdirectory of the synchronization directory.

The unified directory structure may be generated based on a directory of one of the first filesystem and the second filesystem. Thus, in some implementations, the method further comprises generating the unified directory structure by replicating at least a portion of a directory structure rooted at the synchronization directory.

In some implementations, one or more additional files may be added to the set of files to be synchronized. Thus, in some implementations, the method further comprises:
receiving an indication of at least one additional file to be synchronized; and
updating the index to include, in respect of the at least one additional file, an indication of each of a state associated with the first filesystem, a state associated with the second filesystem, and a synchronized state.

In implementations wherein the files are associated with a unified directory structure being indicative of both of a first directory structure with which the files are associated on the first filesystem and a second directory structure with which the files are associated on the second filesystem, the additional file(s) may become part of those to be synchronized between the filesystems as a result of becoming associated with at least one of a directory of the first directory structure and a directory of the second directory structure. Thus, in some implementations, receiving the indication of the at least one additional file comprises receiving an indication that the at least one additional file has become associated with at least one of a directory of the first directory structure and a directory of the second directory structure. For example, such indication may be received from the first electronic device, the second electronic device, or elsewhere.

When the state of one or more files changes in one of the filesystems (e.g. because the file is deleted or modified/replaced), the index may need to be updated and a write operation may need to be performed by one of the other filesystems to maintain synchronization of the files across the filesystems. This may occur if one or more of the files are deleted from the first filesystem, for example. Thus, in some implementations, the method further comprises:
appreciating a deletion of at least one of the files from the first filesystem;
updating the index to indicate the deletion in respect of the at least one of the files;
performing an analysis of the updated index in respect of the at least one of the files;

and
based on the analysis, causing deletion by the second electronic device of at least one of the at least one of the files from the second filesystem.

In various implementations, one or more of the files synchronized between the first electronic device and the second electronic device may also be synchronized between the first electronic device and a third electronic device in communication with the first electronic device, and the third electronic device may therefore either cause deletion or modification of one or more of the files to be synchronized on the first filesystem. Thus, in some implementations, the deletion of the at least one of the files from the first filesystem is a deletion having been caused by a third electronic device in communication with the first electronic device.

The index may also need to be updated if one or more of the files have been modified on the first filesystem. Thus, in some implementations, the method further comprises:
appreciating a modified state associated with the first filesystem in respect of at least one of the files;
updating the index to indicate the modified state instead of the first state in respect of the at least one of the files;
performing an analysis of the updated index in respect of the at least one of the files; and
based on the analysis, causing transmission of the at least one of the at least one of the files from the first electronic device to the second electronic device and writing by the second electronic device of the transmitted at least one of the at least one of the files to the second filesystem.

In some implementations, appreciating the modified state associated with the first filesystem in respect of the at least one of the files occurs as a consequence of a modification of the at least one of the files on the first filesystem having been caused by a third electronic device in communication with the first electronic device. In some implementations, performing the analysis of the updated index comprises comparing the modified state to at least one of the second state and the third state. The comparison may enable a determination as to what operation(s), if any, need(s) to be performed to maintain synchronization of the files across the filesystems.

In some cases, the respective state associated with each filesystem may be the same (e.g., in some implementations, when the one or more files are synchronized across the filesystems). In such cases, there is no need to maintain separate indications of the first state, the second state, and the third state. Rather, all three states may be represented by a single element (e.g. a single value or object). For example, as a matter of design, the absence of explicit information about the first state and/or the second state could be construed to mean that that state is equal to the third state, in which case only the third state would need to be explicitly indicated. Thus, in some implementations and under certain circumstances, each of the first state, the second state, and the third state is a same state in respect of at least one of the files, and the indication of each of the first state, the second state and the third state is a single indication of the same state. A similar logic applies should only one of the first state and the second state be the same as the third state. Thus, in some implementations, one of the first state and the second state is a same state as the third state in respect of at least one of the files, and the indication of each of the third state and the one of the first state and the second state is a single indication of the same state.

The method may be carried out by any appropriately structured and configured electronic device. In some implementations, the method is carried out by the first electronic device and the index is generated in a non-transitory computer-readable medium of the first electronic device. In other implementations, the method is carried out by the second electronic device and the index is generated in a non-transitory computer-readable medium of the second electronic device. In other implementations, the method is carried out by another device being neither the first electronic device nor the second electronic device.

In another aspect, various implementations of the present technology provide a computer-implemented method for managing file synchronization between a client filesystem of a client device and a server filesystem of a server, the client device being in communication with the server via a communications network, the method comprising, at the client device:
identifying files to be synchronized between the client filesystem and the server filesystem; and
generating an index that includes, in respect of each one of the files:
   an indication of each of a client state associated with the client filesystem, a server state associated with the server filesystem, and a synchronized state; and
   an association with at least one directory of a unified directory structure, the unified directory structure being indicative of both of a client directory structure with which the files are associated on the client filesystem and a server directory structure with which the files are associated on the server filesystem.

In some implementations, the method further comprises, at the client device:
appreciating a modified state of at least one of the files associated with the client filesystem;
updating the index to indicate the modified state instead of the client state in respect of the at least one of the files;
performing an analysis of the updated index in respect of the at least one of the files; and; and
based on the analysis, transmitting at least one of the at least one of the files to the server and causing writing by the server of the transmitted at least one of the at least one of the files to the server filesystem.

In some implementations, the method further comprises, at the client device:
receiving an indication from the server of a modified state of at least one of the files associated with the server filesystem;
updating the index to indicate the modified state instead of the server state in respect of the at least one of the files;
performing an analysis of the updated index in respect of the at least one of the files; and
based on the analysis, causing transmission of at least one of the at least one of the files from the server to the client device and writing the transmitted at least one of the at least one of the files to the client filesystem.

In another aspect, various implementations of the present technology provide an electronic device suitable for carrying out one or more above-described methods. Thus, various implementations may provide an electronic device for managing file synchronization between a first filesystem and a second filesystem, the electronic device comprising:
a non-transitory computer-readable medium having encoded thereon the first filesystem;
a communications interface structured and configured to communicate via a communications network with a second electronic device including the second filesystem; and
at least one processor operationally connected to the communications interface, the first non-transitory computer-readable medium, and the second non-transitory computer-readable medium, and structured and configured to:
   identify files to be synchronized between the first filesystem and the second filesystem; and
   generate an index that includes, in respect of each one of the files, an indication of each of a first state associated with the first filesystem, a second state associated with the second filesystem, and a third state being a synchronized state.

Various implementations may provide an electronic device for managing file synchronization between a first filesystem and a second filesystem, the electronic device comprising:
a non-transitory computer-readable medium;
a communications interface structured and configured to communicate via at least one communications network with each one of a first electronic device including the first filesystem and a second electronic device including the second filesystem; and
at least one processor operationally connected to the communications interface and the non-transitory computer-readable medium and structured and configured to:
   identify files to be synchronized between the first filesystem and the second filesystem; and
   generate an index that includes, in respect of each one of the files, an indication of each of a first state associated with the first filesystem, a second state associated with the second filesystem, and a third state being a synchronized state.

In another aspect, various implementations of the present technology provide a non-transitory computer-readable medium having encoded thereon program instructions executable by a processor of an electronic device to carry out one or more above-described methods. Thus, various implementations may provide a non-transitory computer-readable medium having encoded thereon program instructions executable by at least one processor to effect:
identification of files to be synchronized between a first filesystem of a first electronic device and a second filesystem of a second electronic device, the second electronic device being in communication with the first electronic device via a communications network; and
generation of an index that includes, in respect of each one of the files, an indication of each of a first state associated with the first filesystem, a second state associated with the second filesystem, and a third state being a synchronized state.

In the context of the present specification, a “server” is one or more digital electronic devices, possibly but not necessarily including one or more processors running appropriate software, capable of receiving requests (e.g. from client devices) over a network, and carrying out those requests or causing those requests to be carried out. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included herein wherever the expression “server” is used.

In the context of the present specification, a “client device” is a digital electronic device, possibly but not necessarily including one or more processors running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, the expression “information” includes information of any nature or kind whatsoever capable of being stored in a database. Thus information includes, but is not limited to, audiovisual works (images, movies, sound records, presentations etc.), data (location data, numerical data, etc.), text (opinions, comments, questions, messages, etc.), documents, spreadsheets, etc.

In the context of the present specification, an “indication of” an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular filesystem, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the “state” of a file may refer to the contents of the file and/or to metadata associated with the file, depending on the implementation.

Thus, in some implementations, a first state associated with a first filesystem in respect of a file may be said to differ from a second state associated with a second filesystem in respect of the file by virtue of the fact that the contents of the file as stored on the first filesystem are different than the contents of the file as stored on the second filesystem. In other implementations, the states of the file respectively associated with the first filesystem and the second filesystem may be said to differ even though the contents of the file are the same, for example because first metadata associated with the file (non-exhaustive examples of which include its filename, creation time, modification time, version number, etc.) on the first filesystem differs from second metadata associated with the file on the second filesystem. As such, modifying metadata associated with a file on a first filesystem may, in some implementations, be considered a modification of the state of the file associated with the first filesystem which may give rise to a need for synchronization of the metadata associated with the file to a second filesystem.

In the context of the present specification, the expression “computer-readable medium” is intended to include media of any nature and kind whatsoever, including RAM, ROM, disks (CD-ROMs, DVDs, floppy disks, hard drives, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a diagram depicting an example of a conventional technique for determining operations to be performed to synchronize files between a client filesystem and a server filesystem;

FIG. 2 is a context diagram of a networked computing environment suitable for use with implementations of the present technology;

FIG. 3 is a diagram of a computer system including various hardware components, suitable for use with implementations of the present technology;

FIG. 4 is a block diagram depicting a system for implementing the present technology using various logical components;

FIG. 5 is a diagram illustrating an exemplary unified index according to an implementation of the present technology;

FIG. 6 is a table showing various potential combinations of state information with respect to a file or directory to be synchronized between a first filesystem and a second filesystem;

FIG. 7 is a table showing file and index operations to be performed in each of a variety of possible situations according to an exemplary implementation of the present technology; and

FIGS. 8 to 12 are flowcharts illustrating various method implementations of the present technology.

### DETAILED DESCRIPTION

It should be noted that all examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simple implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. Software modules, or simply modules which are implied to be software, may be represented herein as any combination of flowchart elements or other elements indicating performance of process steps and/or textual description. Such modules may be executed by hardware that is expressly or implicitly shown. It should also be noted that, unless otherwise explicitly specified herein, the drawings are not to scale.

We will now consider some non-limiting, illustrative examples to illustrate various implementations of aspects of the present technology.

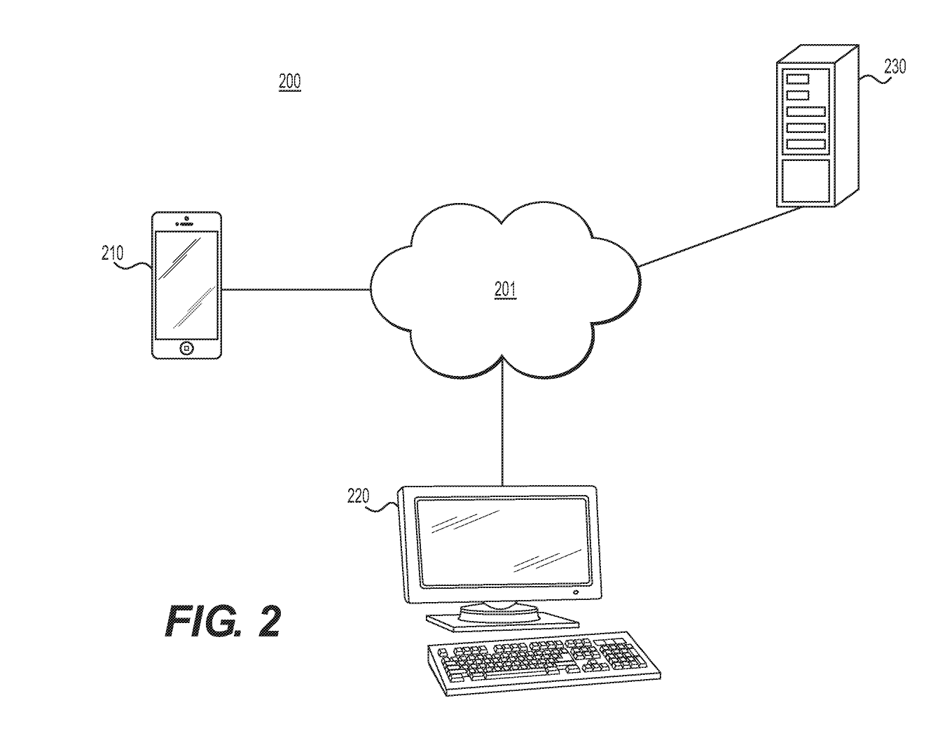

Referring to FIG. 2, there is shown a diagram depicting an exemplary arrangement 200 of a smartphone 210 and a personal computer 220, each of which is in communication with a server 230 via communications network 201 (e.g. the Internet, a local area network, or any other suitable communications network). In other implementations (not depicted), smartphone 210 and personal computer 220 may each be in communication with server 230 via a distinct communication network instead of via a same communications network 201. Representative networking technologies which could be used to implement communications network 201 include, but are not limited to, dial-up, leased line, ISDN, optical, broadband, power-line networking, fiber-optics, DSL, Wi-Fi, cable, satellite, and mobile phone, among others. Known internetworking protocols (i.e. TCP/IP) may be used in conjunction with such technologies along with higher level protocols (i.e. HTTP) to effect communications between electronic devices coupled to communications network 201.

Smartphone 210 may be a standard smartphone such as an Apple iPhone™ running an Apple iOS™ operating system or a Samsung Galaxy™ S-series smartphone running a Google Android™ operating system, and personal computer 220 may be a standard desktop computer running a standard operating system such as Microsoft Windows™ or Apple OSX™. Server 230 may be one or more physical computers and/or virtual machines structured and configured to perform tasks as necessary to accomplish the functions described below.

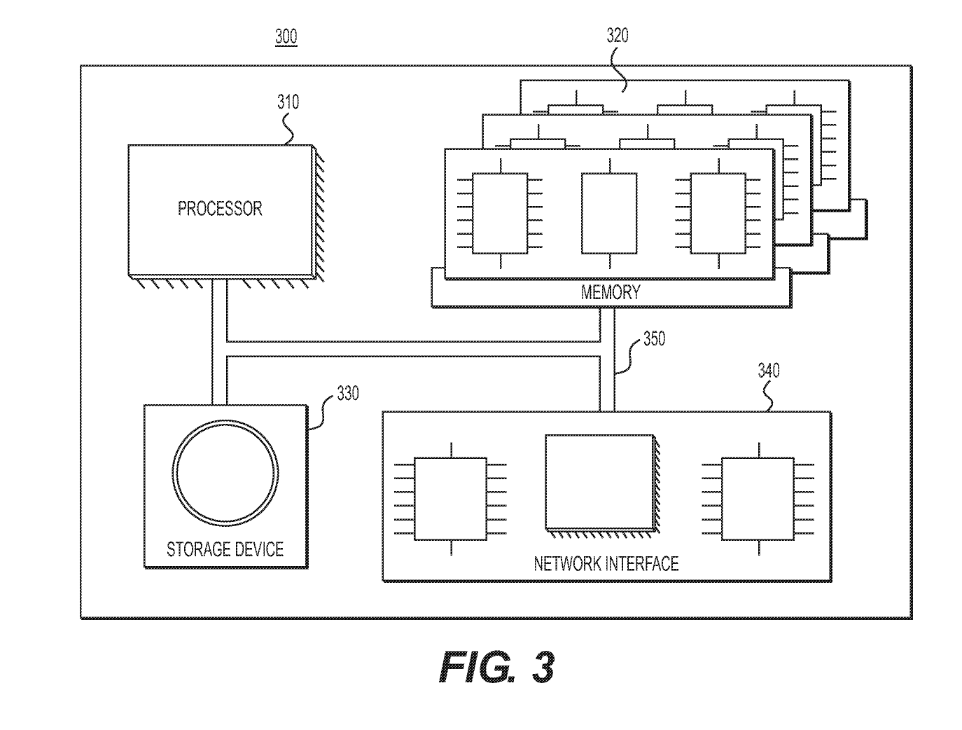

With reference to FIG. 3, an exemplary implementation of each of smartphone 210, personal computer 220, and server 230 may be a computer system 300 including various hardware components: one or more single or multi-core processors 310, a memory 320, a storage device 330, and a network interface 340 (suitable for communication via the communications network 201 of FIG. 2). Communication between the various components is enabled by one or more internal and/or external buses 350 (such as a PCI bus or USB), to which the components are electronically coupled. Above-described methods of the present technology may be implemented on the computer system 300. For example, computer system 300 may comprise or have access to a non-transitory computer-readable medium (e.g. memory 320) having encoded thereon program instructions executable by at least one processor (e.g. processor 310) to effect one or more above-described methods.

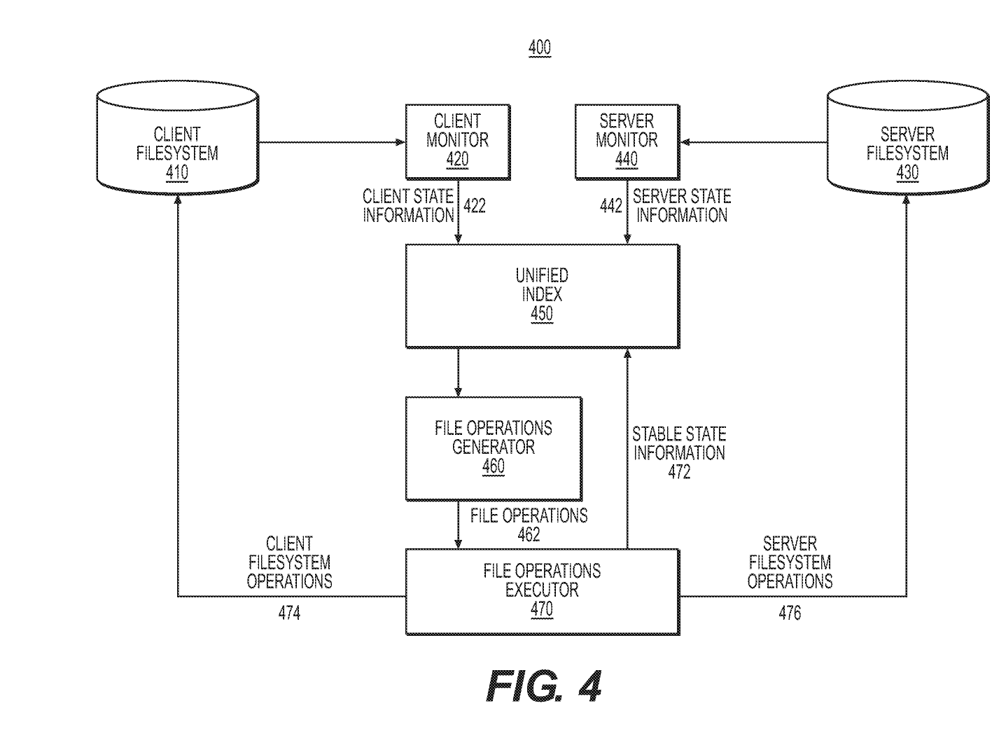

With reference to FIG. 4, an exemplary file synchronization system 400 implementing aspects of the present technology is shown. The depicted system enables synchronization of files between a client filesystem 410 and a server filesystem 430. It will be understood that the various block elements of FIG. 4 are merely logical components, each of which could be physically implemented using any suitable hardware (optionally including one or more processors running suitable software). As such, each of client filesystem 410 and server filesystem 430 may each be understood to represent a file storage service implementing a file storage interface. Said file storage interface may include one or more commands for obtaining a listing of files stored in the filesystem (including state information about the files such as filenames, creation and modification dates and times, file permissions, size, type, file-integrity hash, etc.) and one or more commands for performing one or more write operations (including deletions) in respect of one or more files. In a non-limiting exemplary implementation represented in FIGS. 2 and 4, client filesystem 410 is a file storage service of smartphone 210 of FIG. 2 (perhaps utilizing flash memory for storage) and server filesystem 430 is a file storage service of server 230 (perhaps utilizing a solid-state drive for storage).

Moreover, any of the other logical components depicted in FIG. 4 may be implemented individually or collectively using electronic hardware (optionally including one or more processors running appropriate software), and each component may be either co-located with one or both of client filesystem 410 and server filesystem 430 or located on separate hardware in communication with each of the filesystems, whether via a direct link or via a communications network. In a non-limiting exemplary implementation, each of the client monitor 420, the server monitor 440, the unified index 450, the file operations generator 460, and the file operations executor 470 is implemented as software (i.e. program instructions) resident in a memory 320 of smartphone 210 and executable by a processor 310 of smartphone 210 (with reference again to FIG. 2). Being co-located with client filesystem 410, communication between each of these components and between any one of these components and client filesystem 410 may be effected locally, for example via references to shared memory, interprocess communication, and/or one or more buses 350 of smartphone 210. In turn, communication between server filesystem 430 and each of server monitor 440 and file operations executor 470 may take place via communications network 201 (as depicted in FIG. 2) to which a respective network interface 340 (depicted in FIG. 3) of each of smartphone 210 and server 230 may be operatively coupled.

Broadly speaking, the non-limiting exemplary file synchronization system 400 depicted in FIG. 4 operates as follows. Client monitor 420 periodically interacts with client filesystem 410 using a file listing command of its file storage interface (described above) to obtain information representative of the state of the one or more files stored on client filesystem 410 which are to be synchronized with server filesystem 430. Based on the information so obtained, client monitor 420 updates unified index 450 in respect of the one or more files with client state information 422. Likewise, server monitor 440 regularly interacts with server filesystem 430 using a file listing command of its file storage interface to obtain information representative of the state of the one or more files with respect to server filesystem 430 and updates unified index 450 with server state information 432. Those skilled in the art will readily understand that in various implementations, information may be obtained by the client monitor 420 from the client filesystem 410 (and likewise by the server monitor 440 from the server filesystem 430) in a variety of ways, such as by periodically polling the respective filesystem as described above or by registering with a filesystem monitoring component (not depicted) to receive notifications therefrom whenever relevant changes to the files and/or directories being synchronized are observed.

With continued reference to FIG. 4, updates to the unified index 450 trigger operation of file operations generator 460, which evaluates the updated information in the unified index 450 in respect of each of the files and determines corresponding file operations 462 to be caused by file operations executor 470 in order to effect synchronization of the files. An exemplary implementation of a file operations generator 460 will be described in detail below. File operations executor 470 interprets the file operations 462 and interacts with client filesystem 410 via one or more commands of its file storage interface to cause it to perform one or more client filesystem operations 474. File operations executor 470 also updates unified index 450 with synchronized state information 472, optionally after waiting for and receiving feedback from client filesystem 410 with regard to the success or failure of client filesystem operations 474. Likewise, file operations executor 470 interacts with server filesystem 430 via one or more commands of its file storage interface to cause it to perform one or more server filesystem operations 476. File operations executor 470 again updates unified index 450 with synchronized state information 472, optionally after waiting for and receiving feedback from server filesystem 430 with regard to the success or failure of server filesystem operations 476. In this manner, unified index 450 is used to represent each of a state associated with the client filesystem 410, a state associated with the server filesystem 430, and a synchronized state of each of the files to be synchronized.

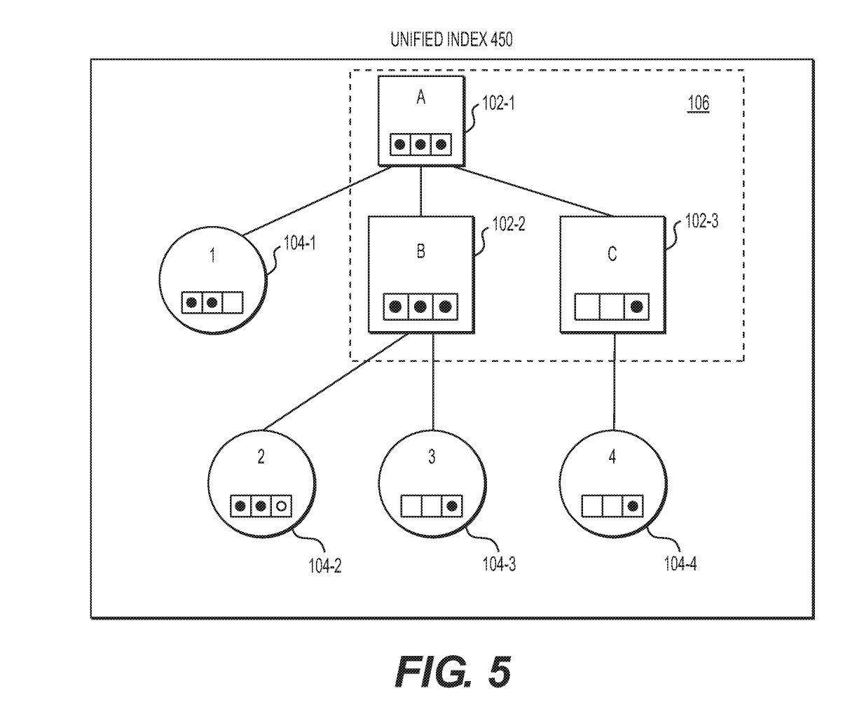

A simple example of such a unified index 450 is shown in FIG. 5. Four files (104-1, 104-2, 104-3, and 104-4) are included in the unified index 450. Each one of the files is associated with a single directory of a unified directory structure 106: file 104-1 being associated with directory “A” (102-1), file 104-2 and file 104-3 being associated with directory “B” (102-2), and file 104-4 being associated with directory “C” (102-3). Unified directory structure 106 is a tree structure with directory “A” (102-1) as its root directory, and each of directory “B” (102-2) and directory “C” (102-3) as immediate subdirectories of directory “A” (102-1).

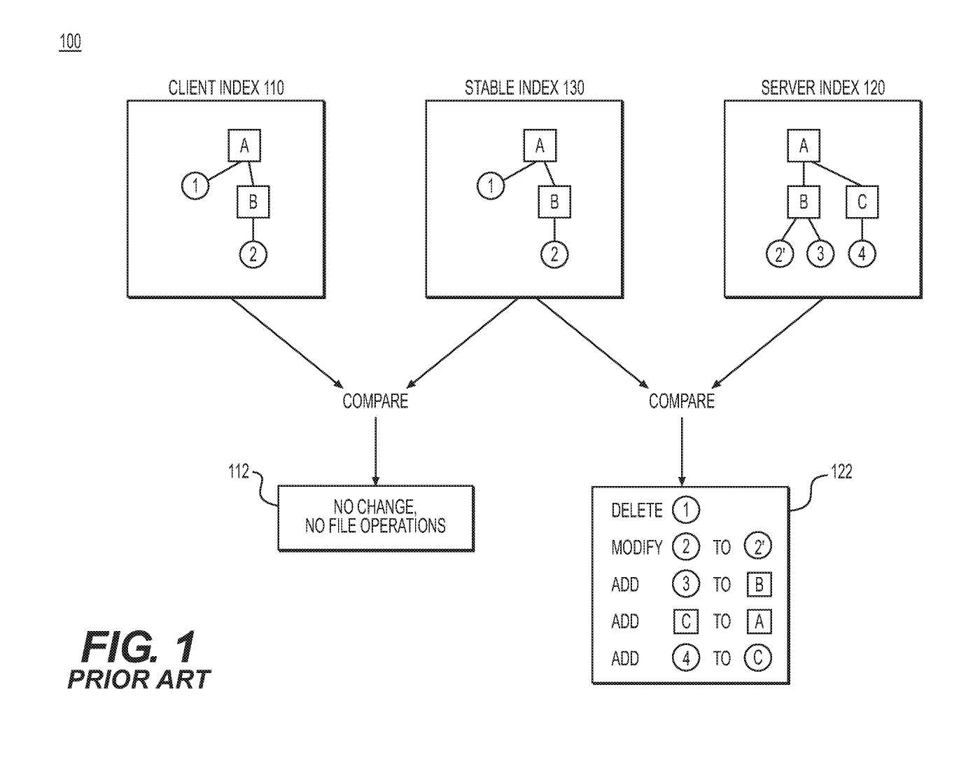

The unified index 450 of FIG. 5 represents state information equivalent to that shown in FIG. 1 using a conventional three-index approach. Each of the files 104 and directories 102 of the unified index 450 has state information associated therewith which is symbolically represented by three square boxes shown in respect of each of the files 104 and directories 102, the first box representing the synchronized state, the second box representing the client state, and the third box representing the server state. When the second box or third box is empty (e.g. the second box of directory 102-3 or the third box of file 104-1), it indicates that the file or directory is not currently stored in the filesystem corresponding to that box. When the first box is empty (e.g. the first box of directory 102-3), it indicates that there is no synchronized state information stored in respect of the file or directory, or in other words, that as of the last completed synchronization, there was no record of the file or directory being stored on either of the client filesystem 410 or the server filesystem 430. When the second or third box contains either a black dot or a hollow dot, it indicates that a corresponding state of a file or directory is stored in the corresponding filesystem. Thus, when both the second box and the third box contain a black dot (e.g. directory 102-1), the client filesystem 410 and the server filesystem 430 are storing a same state of the file or directory, whereas when one contains a black dot and the other a hollow dot (e.g. file 104-2), they are storing different states of the file or directory. The presence of a black or hollow dot in the first box indicates the synchronized state of the file or directory as of the last synchronization.

Those skilled in the art will also observe that the unified directory structure 106 of unified index 450 depicted in FIG. 5 is indicative of both of the directory structure with which the files are associated on the client filesystem 410 (depicted in client index 110 of FIG. 1) and the directory structure with which the files are associated on the server filesystem 430 (depicted in server index 120 of FIG. 1), by virtue of a composite directory structure including each of the directories (102-1, 102-2, 102-3) included in either one of those directory structures, along with state information associated with each of the directories (102-1, 102-2, 102-3), wherein the state information includes an empty box whenever the corresponding directory is absent from one of the directory structures. For example, as shown in FIG. 5, the second box of directory 102-3 is blank to indicate that directory 102-3 is not present in the directory structure of the client filesystem 410. It is to be expressly understood that the foregoing is just one approach for indicating both of the directory structure with which the files are associated on the client filesystem 410 and the directory structure with which the files are associated on the server filesystem 430. The present technology is not limited to this approach, which is merely illustrative.

With these fundamentals in place, we may now go on to consider possible combinations of state information and corresponding operations to be performed to enable synchronization of files between filesystems using a unified index 450.

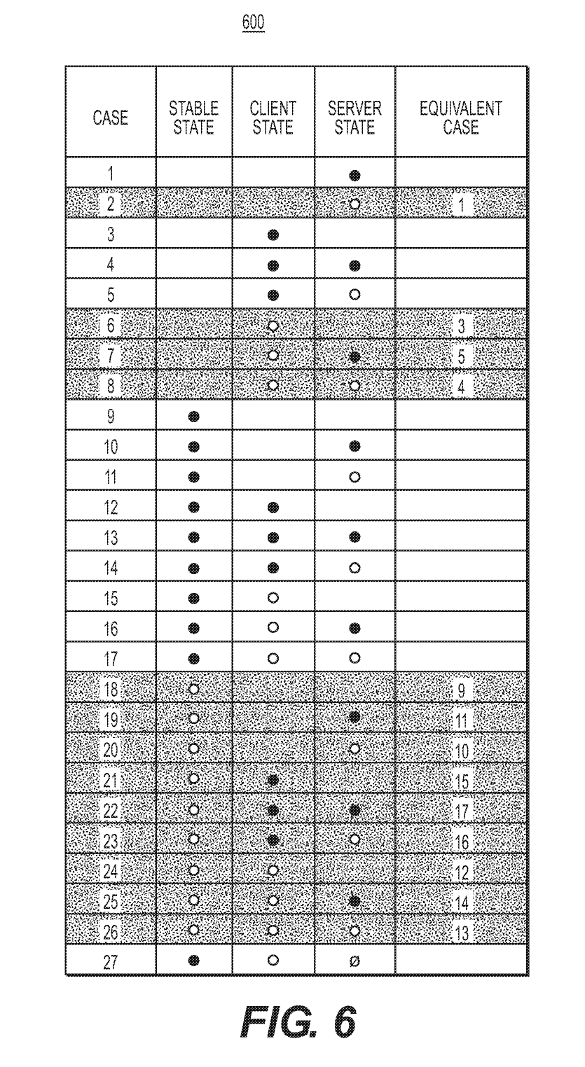

In FIG. 6, various combinations of state information are shown in a table 600 (i.e. as “cases” 1 to 27). As explained above, each of the synchronized state, the client state, and the server state may be represented either by an empty box or a box containing a dot. Table 600 contemplates 27 possible combinations of state information, with the purpose of illustrating that some combinations are functionally equivalent to others with respect to the determination of appropriate operations to be performed to achieve file synchronization. Cases made functionally redundant because of their equivalence to other cases have been displayed with a gray background in table 600, with their equivalent cases indicated in the final column. For example, case 2 is equivalent to case 1 because they both represent states wherein a file/directory is stored on the server filesystem 430 but not on the client filesystem 410, and there is no record of that file/directory as of the last synchronization. Cases 5 and 7 are equivalent because they both represent states wherein the client filesystem 410 and the server filesystem 430 are storing different states of a file/directory, and there is no record of that file/directory as of the last synchronization.

Case 27, shown in the last row of table 600, is a unique case wherein the client filesystem 410 and the server filesystem 430 is each storing a different state of a file/directory, and the synchronized state information as of the last completed synchronization indicates yet another state of the file/directory. Therefore, apart from the black dot and the hollow dot, a third type of dot (a hollow dot with a line through it) is used to indicate a third non-null state of the file/directory.

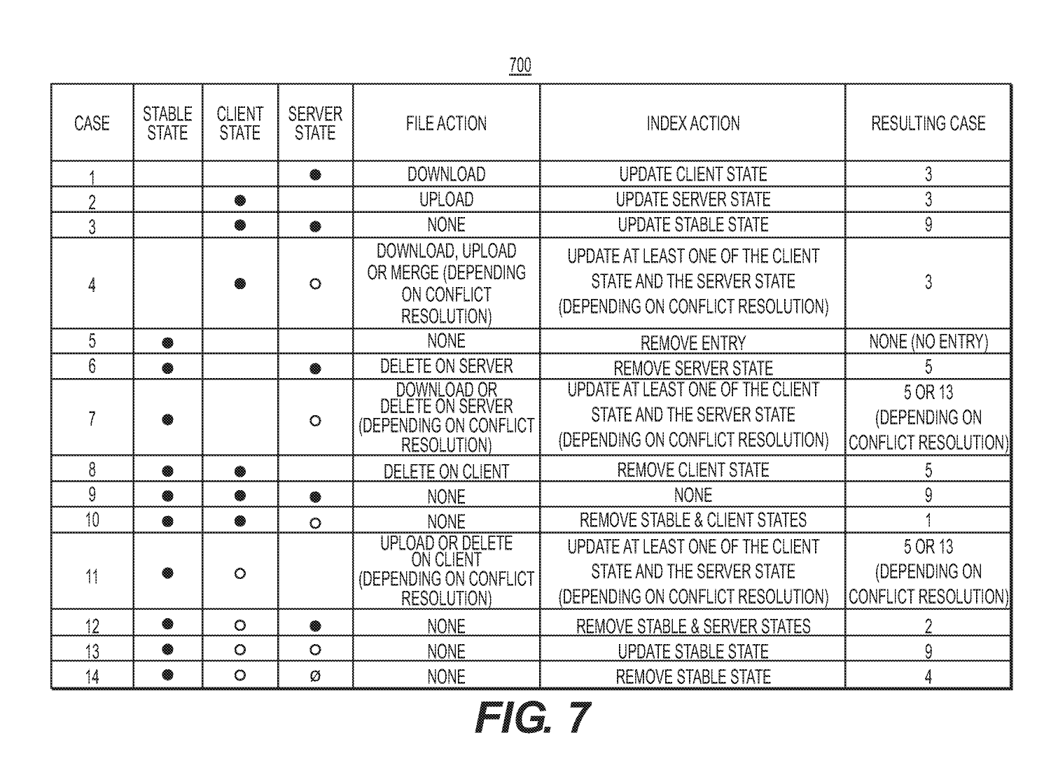

Having established the functional redundancy of some possible combinations of state information, we turn to FIG. 7, which shows a table 700 describing 14 non-redundant states (cases) which may directly or indirectly result from a file or directory having been created, modified, or deleted on at least one of the client filesystem 410 and the server filesystem 430. Also shown in table 700 are corresponding operations (file actions and index actions) deemed appropriate for synchronization of the file or directory according to an implementation of the present technology (e.g. by a file operations generator 460 as depicted in FIG. 4). For each possible value of the state information (i.e. “case”), the updated value of the state information which would result from a successful completion of the one or more files action(s) and index action(s) is also shown (i.e. as the “resulting case”).

First and second states shown as cases 1 and 2 in FIG. 7 may indicate a situation where a new file (or directory) has been created on one of the filesystems. In order to synchronize the file between the filesystems, a transfer (download or upload) operation will need to be performed. The successful completion of that operation will also result in the client state information being updated to reflect the existence of the transferred file on the recipient filesystem. In various implementations, the state information associated with the recipient (i.e. the client state or the server state) may be updated presumptively, that is based on a presumption that the transfer will complete (or has completed) successfully. In other implementations, the state information may be updated only once it is appreciated that the transfer was successful. Once the operations have completed, the resulting state information is that of case 3 (in FIG. 7).

Case 3 may indicate a situation where a same file has been transferred to each of the client filesystem 410 and the server filesystem 430, or more likely a situation where a file has been transferred from one of the filesystems to the other. All that remains to achieve synchronization is to update the synchronized state in the unified index 450 to match the client and server states, which results in the state information of case 9, the stable state.

Cases 4, 7, 11, and 14 represent situations where there is a conflict between the client state and the server state, and the synchronized state is different from both the client state and the server state and therefore does not provide an indication of which one of the client state and the server state is the newer one of the states, which would help to resolve the conflict. In case 4 (and case 14, which reduces to case 4 once the synchronized state information is removed), two distinct states of the file exist, and the conflict needs to be resolved by recourse either to a deterministic (and perhaps arbitrary) rule, such as by preserving/transferring a newer (or older) one of the file states after appreciating their respective timestamps, by asking a user/human intervener to select one state or the other, or, where possible, by merging the two states of the file by incorporating at least a portion of each into a third state of the file. The present technology is not limited to any particular strategy for resolving such conflicts, and various implementations may employ one or more of the above-described techniques or other conflict resolution techniques.

One way or another, case 4 will lead to case 3, since a same state of the file will result from the conflict resolution. In cases 7 and 11, the file does not exist on one of the filesystems, while a new state of the file exists on the other. Again, a choice needs to be made (either by design or on a case-by-case basis, and with or without human intervention) between deleting the new state of the file or transferring it to the other filesystem. In other words, the resulting case will be either one of case 5 and 13, depending on the outcome of the conflict resolution.

It is worth noting that each of the conflict cases 4, 7, 11, and 14 may only occur if the file/directory was separately modified/deleted on each of the client filesystem 410 and the server filesystem 430 before either of the individual modifications was detected by the synchronization system. As such, the likelihood of encountering these cases may be reduced by increasing the frequency with which state information is obtained from each of the filesystems 410, 430. Alternatively, a file-locking mechanism whereby only one of the file stored on the client filesystem 410 and the file stored on the server filesystem may be modified at a given moment may be employed to avoid such cases altogether.

Case 5 indicates a situation where synchronized state information exists for a file that no longer exists on either one of the client filesystem 410 and the server filesystem 430. This is most likely a result of the file having been deleted on one of the filesystems 410, 430, and then being deleted on the other filesystem as a result of an operation of the file synchronization system (i.e. case 6 or case 8).

Case 9 is a special case wherein the file/directory in question is currently synchronized between the two filesystems 410, 430, and the synchronized state also correctly reflects the state of the file stored on both filesystems. In such case, no operations need to be performed, and the resulting case is again case 9, as there is nothing to do until the state information changes.

Cases 10 and 12 indicate situations where a new state of the file/directory has appeared on the server filesystem 430 or client filesystem 410, respectively. Because these situations are effectively equivalent to the appearance of an entirely new file, an appropriate set of operations may be triggered simply by removing the stale state information (i.e. the synchronized state and the client state in case 10, and the synchronized state and the server state in case 12) to result in case 1 or 2, respectively.

Case 13 indicates a situation where a same state of the file/directory is stored on both filesystems 410, 430, but the state information indicates a different (presumably older) state of the file. The corresponding operation is simply to update the synchronized state, leading to the fully-synchronized state of case 9.

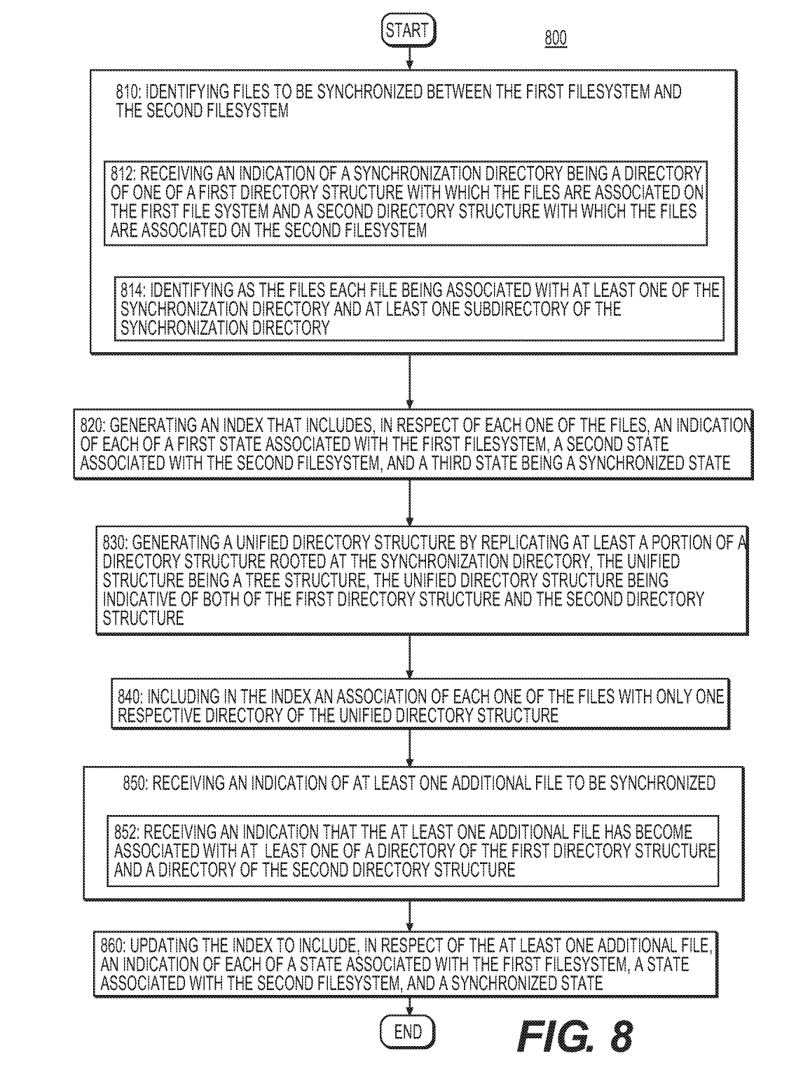

With reference now to FIG. 8, a flowchart corresponding to a first example of a method implementation of the present technology is shown. More specifically, FIG. 8 shows a computer-implemented method 800 for managing file synchronization between a first filesystem of a first electronic device and a second filesystem of a second electronic device, the first electronic device being in communication with the second electronic device via a communications network. Method 800 may be carried out, for example, by server 230 in the networked computing environment of FIG. 2, so as to synchronize files between a server filesystem 430 (a first filesystem) of server 230 (a first electronic device) and a client filesystem 410 (a second filesystem) of smartphone 210 (a second electronic device). Server 230 may comprise hardware (and optional software) which implements various logical components described above with reference to FIG. 4, namely a client monitor 420, server monitor 440, a unified index 450, a file operations generator 460, and a file operations executor 470.

The method 800 comprises several steps. At step 810, files to be synchronized between the first filesystem and the second filesystem are identified. Step 810 comprises steps 812 and 814. At step 812, an indication of a synchronization directory is received, the synchronization directory being a directory of one of a first directory structure with which the files are associated on the first filesystem (e.g. client filesystem 410) and a second directory structure with which the files are associated on the second filesystem (e.g. server filesystem 430). At step 814, each file being associated with at least one of the synchronization directory and at least one subdirectory of the synchronization directory is identified. For example, client monitor 420 may obtain a listing of every file associated with at least one of the synchronization directory and at least one subdirectory (or a subdirectory thereof) of the synchronization directory. At step 820, the unified index 450 of the files is generated (e.g. in a non-transitory computer-readable medium such as memory 320 of server 230), the unified index 450 including, in respect of each one of the files, an indication of each of a first state associated with the first filesystem (server filesystem 430), a second state associated with the second filesystem (client filesystem 410), and a third state being a synchronized state. In some cases, each of the first state, the second state, and the third state may be a same state in respect of at least one of the files, and the indication of each of the first state, the second state and the third state is a single indication of the same state. At step 830, a unified directory structure 106 being a tree structure is generated by replicating at least a portion of a directory structure rooted at the synchronization directory, the unified directory structure 106 being indicative of both of the first directory structure and the second directory structure. At step 840, an association of each one of the files with only one respective directory of the unified directory structure 106 is included in the unified index 450. At step 850, an indication of one or more additional files to be synchronized is received. For example, step 850 may comprise step 852, wherein an indication is received that the at least one additional file has become associated with at least one of a directory of the first directory structure (e.g. stored server filesystem 430) and a directory of the second directory structure (e.g. stored on client filesystem 410). At step 860, the unified index 450 is updated to include, in respect of the at least one additional file, an indication of each of a state associated with the first filesystem (server filesystem 430), a state associated with the second filesystem (client filesystem 410), and a synchronized state.

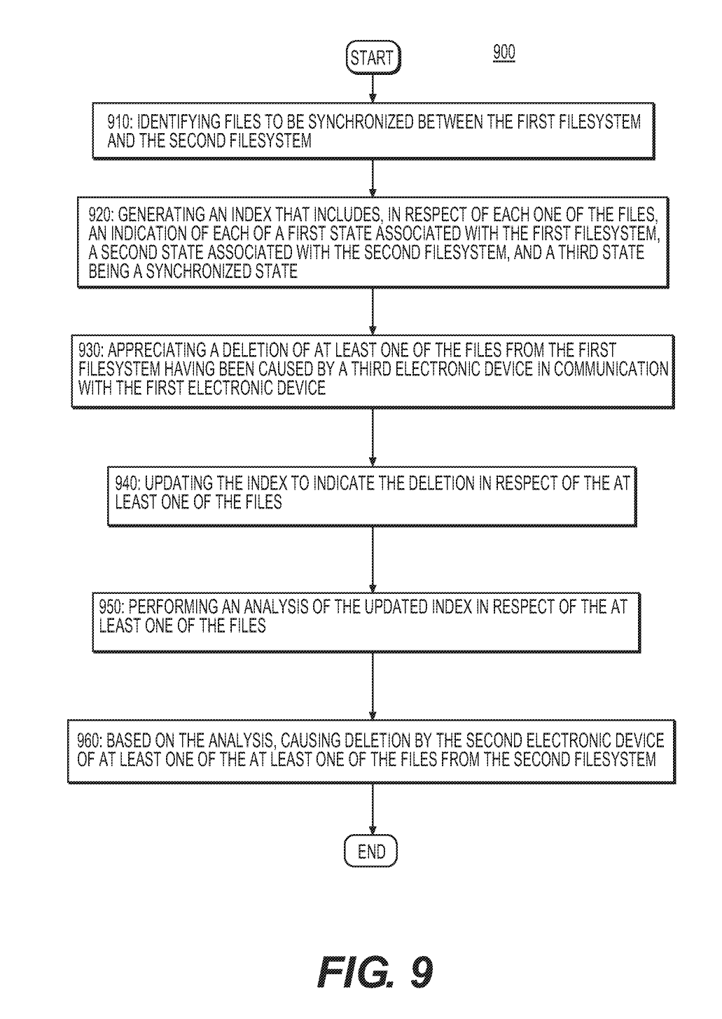

In FIG. 9, a flowchart corresponding to a second example of a method implementation of the present technology is shown. More specifically, FIG. 9 shows a computer-implemented method 900 for managing file synchronization between a first filesystem of a first electronic device and a second filesystem of a second electronic device, the first electronic device being in communication with the second electronic device via a communications network. Method 900 may be carried out, for example, by smartphone 210 in the networked computing environment of FIG. 2, so as to synchronize files between a server filesystem 430 (a first filesystem) of server 230 (a first electronic device) and a client filesystem 410 (a second filesystem) of smartphone 210 (a second electronic device). Smartphone 210 may comprise hardware (and optional software) which implements various logical components described above with reference to FIG. 4, namely a client monitor 420, server monitor 440, a unified index 450, a file operations generator 460, and a file operations executor 470.

Method 900 comprises several steps. At step 910, files to be synchronized between the first filesystem (server filesystem 430) and the second filesystem (client filesystem 410) are identified. At step 920, a unified index 450 of the files is generated (e.g. in a non-transitory computer-readable medium of the second electronic device, such as a memory 320 of smartphone 210), the unified index 450 including, in respect of each one of the files, an indication of each of a first state associated with the first filesystem (server filesystem 430), a second state associated with the second filesystem (client filesystem 410), and a third state being a synchronized state. In some cases, one of the first state and the second state may be a same state as the third state in respect of at least one of the files, and the indication of each of the third state and the one of the first state and the second state may be a single indication of the same state. At step 930, a deletion of at least one of the files from the first filesystem (e.g. server filesystem 430) is appreciated, the deletion having been caused by a third electronic device in communication with the first electronic device. For example, with reference to FIG. 2, both smartphone 210 and personal computer 220 may be configured to synchronize a same file with server 230 via communications network 201, and personal computer 220 (a third electronic device) may cause the file to be deleted by server 230 (the first electronic device), which may result in the server 230 sending a file deletion notification to smartphone 210 (the second electronic device). At step 940, the unified index 450 is updated in respect of the at least one of the files to be indicative of the deletion (e.g. by deleting the server state associated with the at least one of the files from the unified index 450). At step 950, an analysis of the updated unified index 450 is performed in respect of the at least one of the files. For example, a file operations generator 460 of smartphone 210 may perform an analysis of state information included in the unified index 450 as described above with reference to FIG. 7. Finally, at step 960, a deletion by the second electronic device of at least one of the at least one of the files from the second filesystem is caused based on the analysis. For example, a file operations executor 470 of smartphone 210 may cause the at least one of the files to be deleted from client filesystem 410.

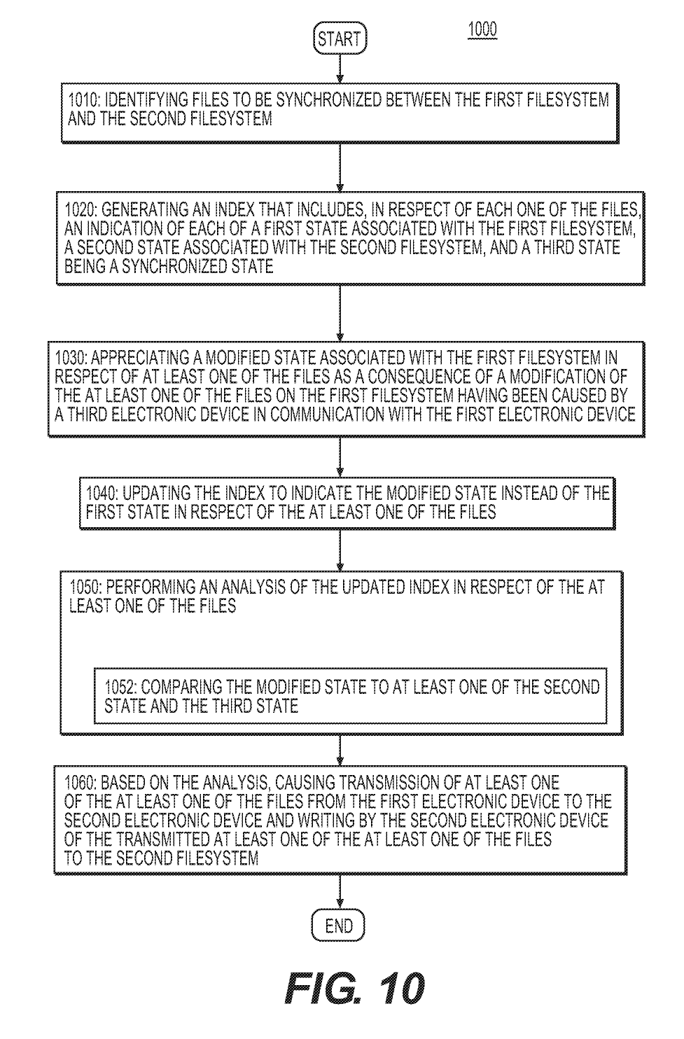

In FIG. 10, a flowchart corresponding to a third example of a method implementation of the present technology is shown. More specifically, FIG. 10 shows a computer-implemented method 1000 for managing file synchronization between a first filesystem of a first electronic device and a second filesystem of a second electronic device, the first electronic device being in communication with the second electronic device via a communications network. Method 1000 may be carried out, for example, by server 230 in the networked computing environment of FIG. 2, so as to synchronize files between a (first) filesystem of personal computer 220 (a first electronic device) and a (second) filesystem of smartphone 210 (a second electronic device).

Method 1000 comprises several steps. At step 1010, files to be synchronized between the first filesystem and the second filesystem are identified. At step 1020 a unified index 450 of the files is generated, the unified index 450 including, in respect of each one of the files, an indication of each of a first state associated with the first filesystem, a second state associated with the second filesystem, and a third state being a synchronized state. At step 1030, a modified state associated with the first filesystem is appreciated in respect of at least one of the files as a consequence of a modification of the at least one of the files on the first filesystem having been caused by a third electronic device in communication with the first electronic device. At step 1040, the unified index 450 is updated in respect of the at least one of the files to indicate the modified state instead of the first state. At step 1050, an analysis of the updated unified index 450 is performed in respect of the at least one of the files. For example, a file operations generator 460 of server 230 may perform an analysis of state information included in the unified index 450 as described above with reference to FIG. 7. Step 1050 may comprise step 1052, wherein the modified state is compared to at least one of the second state and the third state in respect of the at least one of the files. At step 1060, based on the analysis, transmission of the at least one of the at least one of the files from the first electronic device to the second electronic device and writing by the second electronic device of the transmitted at least one of the at least one of the files to the second filesystem are caused. For example, a file operations executor 470 of server 230 may cause the modified state of the at least one of the files to be transferred from personal computer 220 to smartphone 210 and written to a filesystem of smartphone 210.

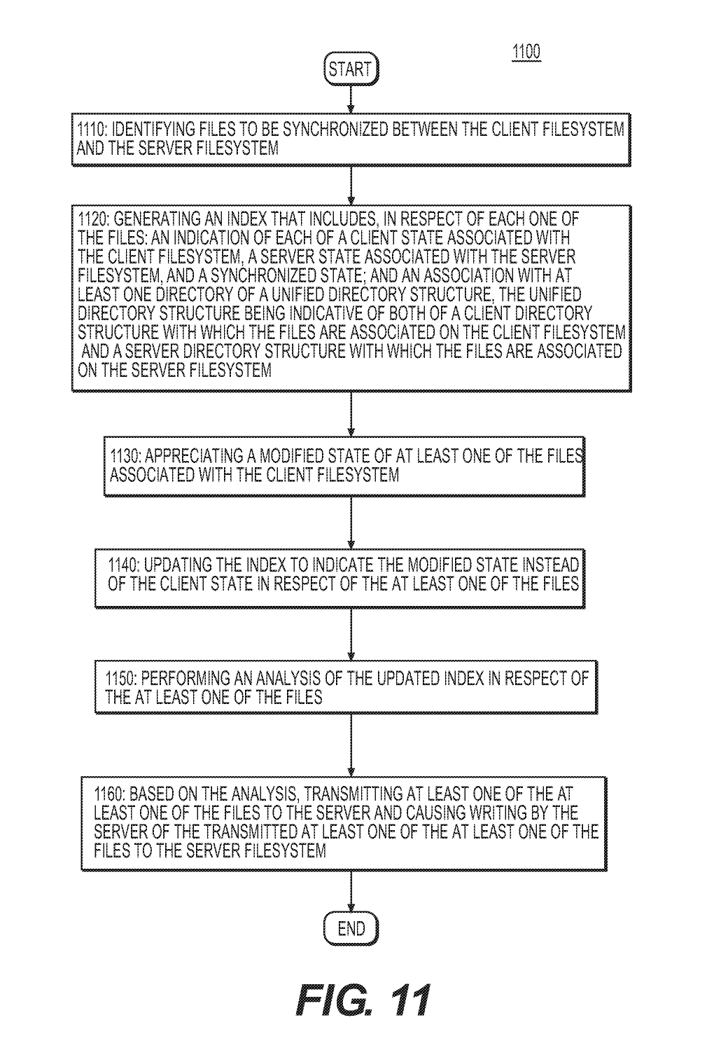

In FIG. 11, a flowchart corresponding to a fourth example of a method implementation of the present technology is shown. More specifically, FIG. 11 shows a computer-implemented method 1100 for managing file synchronization between a client filesystem 410 of a client device (e.g. smartphone 210) and a server filesystem 430 of a server (e.g. server 230), the client device being in communication with the server via a communications network, at the client device.

Method 1100 comprises several steps. At step 1110, files to be synchronized between the client filesystem 410 and the server filesystem 430 are identified. At step 1120, a unified index 450 of the files is generated, the unified index 450 including at least two elements in respect of each one of the files: first, an indication of each of a client state associated with the client filesystem 410, a server state associated with the server filesystem 430, and a synchronized state; and second, an association with at least one directory of a unified directory structure 106, the unified directory structure 106 being indicative of both of a client directory structure with which the files are associated on the client filesystem 410 and a server directory structure with which the files are associated on the server filesystem 430. At step 1130, a modified state associated with the client filesystem 410 is appreciated in respect of at least one of the files (for example, as a result of receiving a file change notification generated by an operating system of the client device). At step 1140, the unified index 450 is updated in respect of the at least one of the files to indicate the modified state instead of the client state. At step 1150, an analysis of the updated state information is performed in respect of the at least one of the files. At step 1160, based on the analysis, at least one of the at least one of the files is transmitted to the server 230 and writing by the server 230 to the server filesystem 430 of the transmitted at least one of the at least one of the files is caused. As a non-limiting example, the client device may send an instruction for writing the transmitted one or more files to the server along with the one or more files.

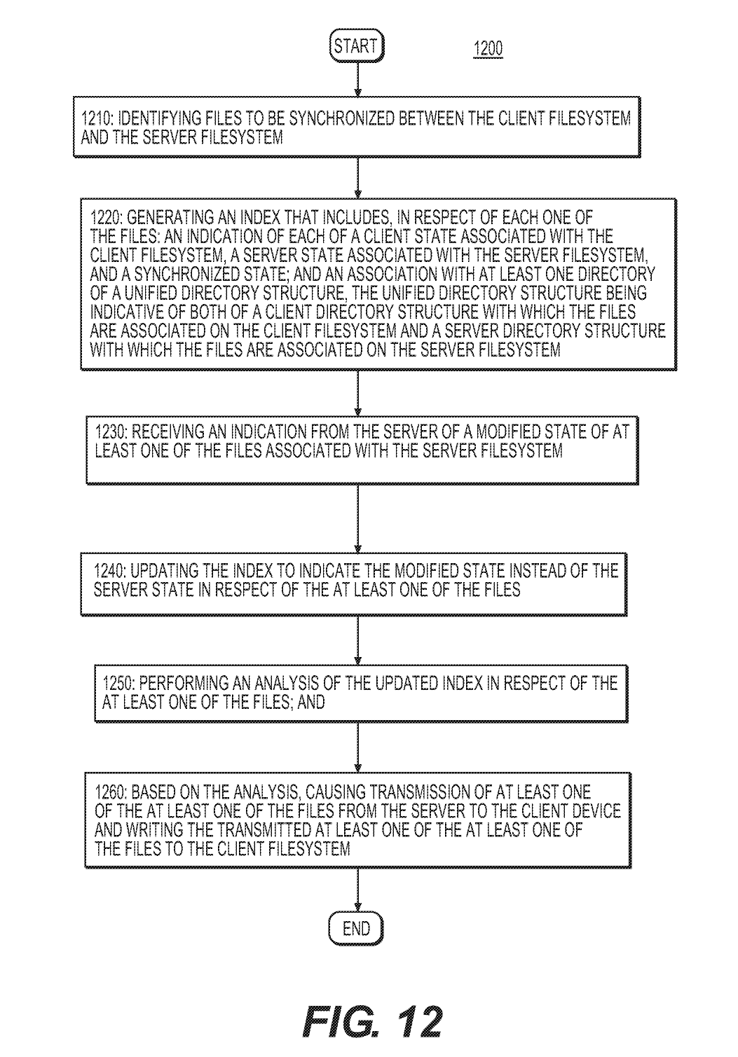

In FIG. 12, a flowchart corresponding to a fifth example of a method implementation of the present technology is shown. More specifically, FIG. 12 shows a computer-implemented method 1200 for managing file synchronization between a client filesystem 410 of a client device (e.g. smartphone 210) and a server filesystem 430 of a server (e.g. server 230), the client device being in communication with the server via a communications network, at the client device.

Method 1200 comprises several steps. At step 1210, files to be synchronized between the client filesystem 410 and the server filesystem 430 are identified. At step 1220, a unified index 450 of the files is generated, the unified index 450 including at least two elements in respect of each of the files: first, an indication of each of a client state associated with the client filesystem 410, a server state associated with the server filesystem 430, and a synchronized state; and second, an association with at least one directory of a unified directory structure 106, the unified directory structure 106 being indicative of both of a client directory structure with which the files are associated on the client filesystem 410 and a server directory structure with which the files are associated on the server filesystem 430. At step 1230, an indication of a modified state associated with the server filesystem is received from the server in respect of at least one of the files. At step 1240, the unified index 450 is updated in respect of the at least one of the files to indicate the modified state instead of the server state. At step 1250, an analysis of the updated unified index 450 is performed in respect of the at least one of the files. For example, a file operations generator 460 of smartphone 210 may perform an analysis of state information included in the unified index 450 as described above with reference to FIG. 7. At step 1260, based on the analysis, transmission from the server to the client device of at least one of the at least one of the files is caused, and the transmitted at least one of the at least one of the files is written to the client filesystem 410. As a non-limiting example, smartphone 210 may initiate a download of the at least one of the at least one of the files from a server filesystem 430 of server 230, and then write one or more received files to a client filesystem 410 stored in a memory 320 of smartphone 210.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for managing file synchronization between a first filesystem of a first electronic device and a second filesystem of a second electronic device, the first electronic device being in communication with the second electronic device via a communications network, the method comprising:
identifying files to be synchronized between the first filesystem and the second filesystem; and
generating a unified index that includes, in respect of each one of the files, an indication of each of a first state associated with the first filesystem, a second state associated with the second filesystem, and a third state being a synchronized state,
the file synchronization between the first filesystem and the second filesystem being executed without maintaining individual indexes for each of the first and second filesystems.

2. The computer-implemented method of claim 1, further comprising including, in the unified index, an association of each one of the files with at least one directory of a unified directory structure, the unified directory structure being indicative of both of a first directory structure with which the files are associated on the first filesystem and a second directory structure with which the files are associated on the second filesystem.

3. The computer-implemented method of claim 2, wherein the unified directory structure is a tree structure and the association of each one of the files with at least one directory of the unified directory structure is an association of each one of the files with only one respective directory of the unified directory structure.

4. The computer-implemented method of claim 1, wherein identifying the files to be synchronized comprises:
receiving an indication of a synchronization directory being a directory of one of the first directory structure and the second directory structure; and
identifying as the files each file being associated with at least one of the synchronization directory and at least one subdirectory of the synchronization directory.

5. The computer-implemented method of claim 4, further comprising generating the unified directory structure by replicating at least a portion of a directory structure rooted at the synchronization directory.

6. The computer-implemented method of claim 1, further comprising:
receiving an indication of at least one additional file to be synchronized; and
updating the unified index to include, in respect of the at least one additional file, an indication of each of a state associated with the first filesystem, a state associated with the second filesystem, and a synchronized state.

7. The computer-implemented method of claim 6, wherein receiving the indication of the at least one additional file comprises receiving an indication that the at least one additional file has become associated with at least one of a directory of the first directory structure and a directory of the second directory structure.

8. The computer-implemented method of claim 1, further comprising:
appreciating a deletion of at least one of the files from the first filesystem;
updating the unified index to indicate the deletion in respect of the at least one of the files;
performing an analysis of the updated unified index in respect of the at least one of the files; and
based on the analysis, causing deletion by the second electronic device of at least one of the at least one of the files from the second filesystem.

9. The computer-implemented method of claim 8, the deletion of the at least one of the files from the first filesystem is a deletion having been caused by a third electronic device in communication with the first electronic device.

10. The computer-implemented method of claim 1, further comprising:
appreciating a modified state associated with the first filesystem in respect of at least one of the files;
updating the unified index to indicate the modified state instead of the first state in respect of the at least one of the files;
performing an analysis of the updated unified index in respect of the at least one of the files; and
based on the analysis, causing transmission of at least one of the at least one of the files from the first electronic device to the second electronic device and writing by the second electronic device of the transmitted at least one of the at least one of the files to the second filesystem.

11. The computer-implemented method of claim 10, wherein appreciating the modified state associated with the first filesystem in respect of the at least one of the files occurs as a consequence of a modification of the at least one of the files on the first filesystem having been caused by a third electronic device in communication with the first electronic device.

12. The computer-implemented method of claim 10, wherein performing the analysis of the updated unified index comprises comparing the modified state to at least one of the second state and the third state.

13. The computer-implemented method of claim 1, wherein each of the first state, the second state, and the third state is a same state in respect of at least one of the files, and the indication of each of the first state, the second state and the third state is a single indication of the same state.

14. The computer-implemented method of claim 1, wherein one of the first state and the second state is a same state as the third state in respect of at least one of the files, and the indication of each of the third state and the one of the first state and the second state is a single indication of the same state.

15. The computer-implemented method of claim 1, wherein the method is carried out by the first electronic device and the unified index is generated in a non-transitory computer-readable medium of the first electronic device.

16. The computer-implemented method of claim 1, wherein the method is carried out by the second electronic device and the unified index is generated in a non-transitory computer-readable medium of the second electronic device.

17. The computer-implemented method of claim 1, wherein the method if carried out by another electronic device being neither the first electronic device nor the second electronic device.

18. A computer-implemented method for managing file synchronization between a client filesystem of a client device and a server filesystem of a server, the client device being in communication with the server via a communications network, the method comprising, at the client device:
identifying files to be synchronized between the client filesystem and the server filesystem; and
generating a unified index that includes, in respect of each one of the files:
an indication of each of a client state associated with the client filesystem, a server state associated with the server filesystem, and a synchronized state; and
an association with at least one directory of a unified directory structure, the unified directory structure being indicative of both of a client directory structure with which the files are associated on the client filesystem and a server directory structure with which the files are associated on the server filesystem,
the file synchronization between the client filesystem and the server filesystem being executed without maintaining individual indexes for each of the client and server filesystems.

19. The computer-implemented method of claim 18, further comprising, at the client device:
appreciating a modified state of at least one of the files associated with the client filesystem;
updating the unified index to indicate the modified state instead of the client state in respect of the at least one of the files;
performing an analysis of the updated unified index in respect of the at least one of the files; and
based on the analysis, transmitting at least one of the at least one of the files to the server and causing writing by the server of the transmitted at least one of the at least one of the files to the server filesystem.

20. The computer-implemented method of claim 18, further comprising, at the client device:
receiving an indication from the server of a modified state of at least one of the files associated with the server filesystem;
updating the unified index to indicate the modified state instead of the server state in respect of the at least one of the files;
performing an analysis of the updated unified index in respect of the at least one of the files; and
based on the analysis, causing transmission of at least one of the at least one of the files from the server to the client device and writing the transmitted at least one of the at least one of the files to the client filesystem.

21. An electronic device for managing file synchronization between a first filesystem and a second filesystem, the electronic device comprising:
a non-transitory computer-readable medium having encoded thereon the first filesystem;
a communications interface structured and configured to communicate via a communications network with a second electronic device including the second filesystem; and
at least one processor operationally connected to the communications interface, the first non-transitory computer-readable medium, and the second non-transitory computer-readable medium, and structured and configured to:
identify files to be synchronized between the first filesystem and the second filesystem; and
generate a unified index that includes, in respect of each one of the files, an indication of each of a first state associated with the first filesystem, a second state associated with the second filesystem, and a third state being a synchronized state,
the file synchronization between the first filesystem and the second filesystem being executed without maintaining individual indexes for each of the first and second filesystems.

22. An electronic device for managing file synchronization between a first filesystem and a second filesystem, the electronic device comprising:
a non-transitory computer-readable medium;
a communications interface structured and configured to communicate via at least one communications network with each one of a first electronic device including the first filesystem and a second electronic device including the second filesystem; and
at least one processor operationally connected to the communications interface and the non-transitory computer-readable medium and structured and configured to:
identify files to be synchronized between the first filesystem and the second filesystem; and
generate a unified index that includes, in respect of each one of the files, an indication of each of a first state associated with the first filesystem, a second state associated with the second filesystem, and a third state being a synchronized state,
the file synchronization between the first filesystem and the second filesystem being executed without maintaining individual indexes for each of the first and second filesystems.

23. (canceled)
